(19) United States
(12) Patent Application Publication
(10) Pub. No.: US 2026/0301667 A1
(43) Pub. Date: Oct. 1, 2026

(54) DISPLAY PANEL AND DRIVING METHOD AND DRIVING DEVICE THEREOF

(71) Applicant: Wuhan Tianma Microelectronics Co., Ltd., Wuhan (CN)

(72) Inventors: Euncheol Eom, Wuhan (CN); Dicai Xia, Wuhan (CN)

(73) Assignee: Wuhan Tianma Microelectronics Co., Ltd., Wuhan (CN)

(21) Appl. No.: 19/556,131

(22) Filed: Mar. 4, 2026

(30) Foreign Application Priority Data
Oct. 14, 2025 (CN) 202511468615.1

(51) Int. Cl. G09G 3/3225

(52) U.S. Cl. CPC G09G 3/3225; G09G 2320/0209; G09G 2320/0233; G09G 2320/0285; G09G 2340/0457; G09G 2360/16

(57) ABSTRACT

Provided are a display panel and a driving method and a driving device thereof. The driving method for a display panel includes: receiving image data of an i-th frame of initial image and acquiring initial input data of pixel circuits in the i-th frame of initial image and reference compensation values of the pixel circuits in the i-th frame of initial image; and according to a reference compensation value of a first pixel circuit, initial input data of the first pixel circuit, and initial input data of a second pixel circuit, determining a target compensation value of the first pixel circuit and performing compensation adjustment on the initial input data of the first pixel circuit, where the first pixel circuit and the second pixel circuit are located in the same pixel column.

### CROSS-REFERENCE TO RELATED APPLICATION

This application claims priority to Chinese Patent Application No. 202511468615.1 filed Oct. 14, 2025, the disclosure of which is incorporated herein by reference in its entirety.

### TECHNICAL FIELD

The present disclosure relates to the field of display technology and, in particular, to a display panel and a driving method and a driving device thereof.

### BACKGROUND

With the development of display technology, display panels are increasingly widely used, and correspondingly, the requirements for the display effects of the display panels are also increasing.

Currently, a display panel is prone to vertical crosstalk when displaying an image, resulting in inconsistent brightness in different regions of the display panel.

### SUMMARY

The present disclosure provides a display panel and a driving method and a driving device thereof to mitigate vertical crosstalk in existing display panels.

According to an aspect of the present disclosure, a driving method for a display panel is provided. The display panel includes multiple pixel columns and multiple data lines, a pixel column of the multiple pixel columns includes multiple pixel circuits, and the multiple pixel circuits are electrically connected to a same data line of the multiple data lines.

The driving method includes the steps below.

Image data of an i-th frame of initial image is received, and initial input data of pixel circuits in the i-th frame of initial image and reference compensation values of the pixel circuits in the i-th frame of initial image are acquired.

According to a reference compensation value of a first pixel circuit, initial input data of the first pixel circuit, and initial input data of a second pixel circuit, a target compensation value of the first pixel circuit is determined, and compensation adjustment is performed on the initial input data of the first pixel circuit.

The first pixel circuit and the second pixel circuit are located in a same pixel column of the multiple pixel columns.

According to another aspect of the present disclosure, a driving device for a display panel is provided. The display panel includes multiple pixel columns and multiple data lines, a pixel column of the multiple pixel columns includes multiple pixel circuits, and the multiple pixel circuits are electrically connected to a same data line of the multiple data lines.

The driving device includes the circuits below.

An image processing circuit is configured to receive image data of an i-th frame of initial image, and acquire initial input data of pixel circuits in the i-th frame of initial image and reference compensation values of the pixel circuits in the i-th frame of initial image.

A compensation circuit is configured to, according to a reference compensation value of a first pixel circuit, initial input data of the first pixel circuit, and initial input data of a second pixel circuit, determine a target compensation value of the first pixel circuit and perform compensation adjustment on the initial input data of the first pixel circuit.

The first pixel circuit and the second pixel circuit are located in a same pixel column of the multiple pixel columns.

According to another aspect of the present disclosure, a display panel is provided. The display panel includes multiple pixel columns, multiple data lines, and the preceding driving device.

A pixel column of the multiple pixel columns includes multiple pixel circuits, and the multiple pixel circuits are electrically connected to a same data line of the multiple data lines.

The driving device is electrically connected to the multiple data lines and is configured to supply compensated data signals to the multiple data lines.

It is to be understood that the content described in this section is neither intended to identify key or critical features of embodiments of the present disclosure nor intended to limit the scope of the present disclosure. Other features of the present disclosure become easily understood through the description provided below.

### BRIEF DESCRIPTION OF DRAWINGS

To illustrate technical solutions in the embodiments of the present disclosure more clearly, drawings used in the description of the embodiments are briefly described below. Apparently, the drawings described below illustrate some embodiments of the present disclosure, and those of ordinary skill in the art may obtain other drawings based on the drawings described below on the premise that no creative work is done.

FIG. 1 is a diagram of a display panel according to an embodiment of the present disclosure.

FIG. 2 is a diagram of a pixel circuit according to an embodiment of the present disclosure.

FIG. 3 is a diagram of a driving method for a display panel according to an embodiment of the present disclosure.

FIG. 4 is another diagram of a driving method for a display panel according to an embodiment of the present disclosure.

FIG. 5 is another diagram of a driving method for a display panel according to an embodiment of the present disclosure.

FIG. 6 is another diagram of a driving method for a display panel according to an embodiment of the present disclosure.

FIG. 7 is another diagram of a driving method for a display panel according to an embodiment of the present disclosure.

FIG. 8 is a diagram of the brightness of a display panel according to an embodiment of the present disclosure.

FIG. 9 is a diagram of a driving device for a display panel according to an embodiment of the present disclosure.

### DETAILED DESCRIPTION

To make the technical solutions of the present disclosure better understood by those skilled in the art, the technical solutions in the embodiments of the present disclosure are described below clearly and completely in conjunction with the drawings in the embodiments of the present disclosure. Apparently, the embodiments described below are part, not all, of embodiments of the present disclosure. Based on the embodiments of the present disclosure, all other embodiments obtained by those of ordinary skill in the art are within the scope of the present disclosure on the premise that no creative work is done.

It is to be noted that terms such as “first” and “second” in the description, claims, and preceding drawings of the present disclosure are used for distinguishing between similar objects and are not necessarily used for describing a particular order or sequence. It is to be understood that data used in this manner are interchangeable where appropriate so that the embodiments of the present disclosure described herein can be implemented in an order not illustrated or described herein. In addition, the terms “including”, “having”, and any other variations thereof are intended to cover a non-exclusive inclusion. For example, a process, a method, a system, a product, or a device that includes a series of steps or units may include not only the expressly listed steps or units but also other steps or units that are not expressly listed or are inherent to the process, the method, the product, or the device.

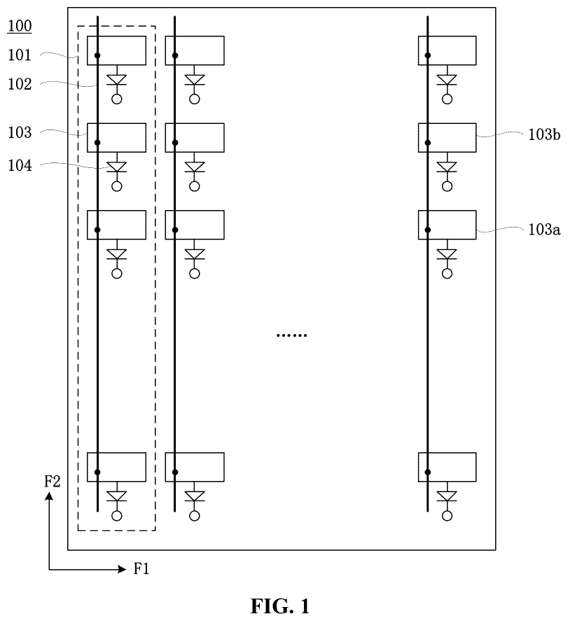

FIG. 1 is a diagram of a display panel according to an embodiment of the present disclosure. As shown in FIG. 1, the display panel 100 includes multiple pixel columns 101 and multiple data lines 102, a pixel column 101 of the multiple pixel columns 101 includes multiple pixel circuits 103, and the multiple pixel circuits 103 are electrically connected to the same data line 102. In this embodiment, the display panel 100 may be an organic light-emitting display panel, a liquid-crystal display panel, or another type of display panel. The type of the display panel is not specifically limited in the present disclosure.

Specifically, the display panel 100 includes the multiple pixel columns 101 arranged in a first direction F1, and the pixel column 101 includes the multiple pixel circuits 103 arranged in a second direction F2. The first direction F1 and the second direction F2 intersect. The display panel 100 includes the multiple data lines 102 arranged in the first direction F1, and the data lines 102 extend in the second direction F2. One data line 102 is electrically connected to at least one pixel column 101 correspondingly. In FIG. 1, one data line 102 is optionally electrically connected to one pixel column 101 correspondingly, and the multiple pixel circuits 103 in the pixel column 101 are electrically connected to the same data line 102. It is to be understood that the first direction F1 is an extending direction of scan lines, and the second direction F2 is an extending direction of the data lines.

Pixel circuits 103 are electrically connected to light-emitting elements 104. It is to be noted that the arrangement of the light-emitting elements 104 in the display panel is diverse. Multiple light-emitting elements 104 electrically connected to the pixel column 101 may be located in different light-emitting element columns. FIG. 1 only illustrates the electrical connection relationship between the pixel circuits 103 and the light-emitting elements 104, and does not limit the actual positions of the light-emitting elements in the display panel.

The display panel 100 includes multiple signal lines configured to supply voltage signals and/or current signals to the pixel circuits 103, thereby enabling the pixel circuits 103 to drive the light-emitting elements 104. As a result, the light-emitting elements 104 emit light for display, allowing the display panel 100 to perform image display. The multiple signal lines in the display panel 100 include the data lines 102. FIG. 1 only shows the data lines 102. The data lines 102 supply data signals to pixel circuits 103 electrically connected to the data lines 102. The configuration of a pixel circuit 103 of the pixel circuits 103 is diverse, so the structure of the pixel circuit 103 is not specifically shown in FIG. 1. FIG. 1 only illustrates the electrical connection relationship between the data lines 102 and the pixel circuits 103 by showing overlappings between the data lines 102 and the pixel circuits 103, which does not limit the overlapping positions and overlapping areas.

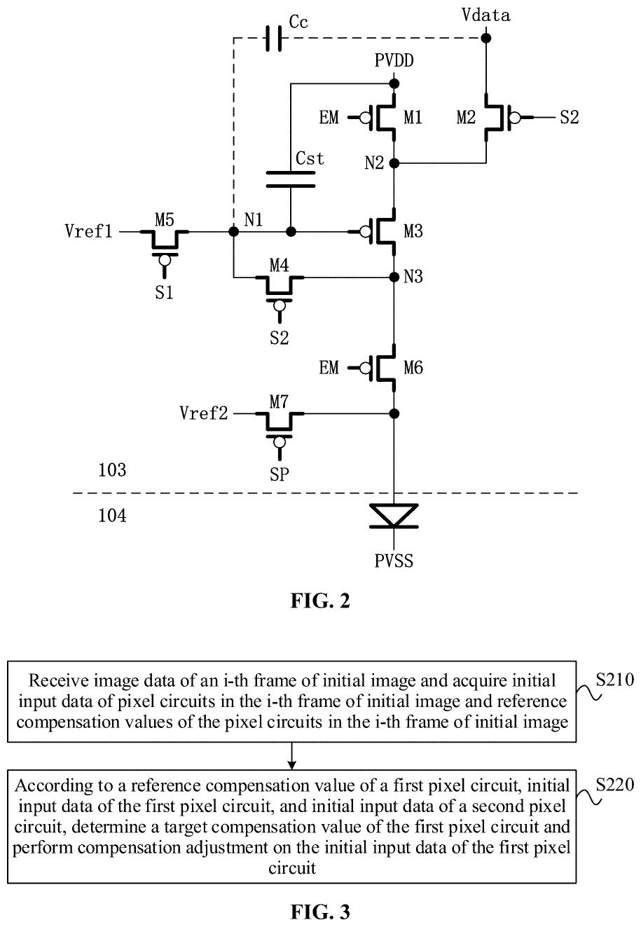

FIG. 2 is a diagram of a pixel circuit according to an embodiment of the present disclosure. As shown in FIG. 2, optionally, the pixel circuit 103 has a structure of 7T1C, where “T” denotes a transistor, and “C” denotes a capacitor. The configuration of the pixel circuit 103 is diverse. Referring to FIG. 2, the pixel circuit 103 is illustrated using an example of “7T1C”. Based on the configuration of the pixel circuit 103, those skilled in the art can make adaptive modifications as needed. Depending on different types of display panels, the structures of pixel circuits in the display panels vary. Moreover, even in the same type of display panels, the structures of pixel circuits also vary. Exemplarily, the structure of a pixel circuit in the organic light-emitting display panel may refer to the 7T1C structure of the pixel circuit 103 shown in FIG. 2, which is not limited herein.

Referring to FIG. 2, the pixel circuit 103 may include a first dimming transistor M1, a data writing transistor M2, a drive transistor M3, a threshold compensation transistor M4, an initialization reset transistor M5, a second dimming transistor M6, an anode reset transistor M7, and a storage capacitor Cst. Optionally, the pixel circuit 103 may include a variety of transistors. As shown in FIG. 2, the multiple transistors in the pixel circuit 103 may include low-temperature polycrystalline silicon (LTPS) transistors. In other embodiments, the multiple transistors in the pixel circuit 103 may include metal oxide transistors, such as indium gallium zinc oxide thin-film transistors (IGZO-TFT). In conjunction with FIGS. 1 and 2, a data line 102 supplies a data signal Vdata to the data writing transistor M2 in the pixel circuit 103.

Currently, when displaying an image, the display panel is prone to vertical crosstalk. Here, the vertical direction may be understood as the extending direction of the data lines. The vertical crosstalk of the display panel causes inconsistent display brightness in different regions of the display panel in the extending direction of the data lines.

The causes of the vertical crosstalk in the display panel are complex and varied. One contributing factor is crosstalk induced by voltage drop (IR Drop) or voltage rising (IR Rising) on a data line. Specifically, based on the manufacturing process of the display panel, a parasitic capacitance Cc may be generated by coupling between a gate N1 of the drive transistor M3 in the pixel circuit 103 and at least one adjacent data line 102. In FIG. 2, the parasitic capacitance Cc is generated between the gate N1 of the drive transistor M3 in the pixel circuit 103 and the data line 102 electrically connected correspondingly, which is not limited herein. A parasitic capacitance Cc may be generated by coupling between the gate N1 of the drive transistor M3 in the pixel circuit 103 and another adjacent data line 102.

Due to the presence of the parasitic capacitance Cc in the pixel circuit 103, in a high-grayscale display region (white) of the display panel, there is a current distribution difference among the multiple pixel circuits 103 electrically connected to the same data line 102. This results in varying IR Drop of the data line 102 in different regions. Such a difference further causes fluctuations in signals of high-voltage power supply terminals PVDD among the multiple pixel circuits 103, ultimately leading to the inconsistent brightness in the different regions of the display panel along the extending direction of the data line. This is the vertical crosstalk induced by the voltage drop (IR Drop) on the data line 102.

Due to the presence of the parasitic capacitance Cc in the pixel circuit 103, in a low-grayscale display region (black) of the display panel, there is a current distribution difference among the multiple pixel circuits 103 electrically connected to the same data line 102. This results in varying IR Rising of the data line 102 in different regions. Such a difference further causes fluctuations in signals of low-voltage power supply terminals PVSS among the multiple pixel circuits 103, ultimately leading to the inconsistent brightness in the different regions of the display panel in the extending direction of the data line. This is the vertical crosstalk induced by the voltage rising (IR Rising) on the data line 102.

As the size of the display panel increases, and the resolution of the display panel improves, coupling crosstalk between the signal lines and the pixel circuits increases. In particular, a reduced gap between the data line 102 and the pixel circuits 103 further increases the coupling crosstalk, exacerbating the vertical crosstalk.

To address the preceding problem, an embodiment of the present disclosure provides a driving method for a display panel. By performing optimization through an algorithm, the vertical crosstalk can be mitigated, and the brightness uniformity of the display panel can be improved, thereby enhancing the image quality and display effects of the display panel. FIG. 3 is a diagram of a driving method for a display panel according to an embodiment of the present disclosure. The structure of the display panel may refer to that shown in FIG. 1. The driving method may be performed by a driving device. The driving device may be implemented in hardware and/or software. Specifically, the driving device may be configured in the display panel, for example, in a display driver chip of the display panel. As shown in FIG. 3, the driving method for a display panel includes the steps below.

In S210, image data of an i-th frame of initial image is received, and initial input data of pixel circuits in the i-th frame of initial image and reference compensation values of the pixel circuits in the i-th frame of initial image are acquired.

In S220, according to a reference compensation value of a first pixel circuit, initial input data of the first pixel circuit, and initial input data of a second pixel circuit, a target compensation value of the first pixel circuit is determined, and compensation adjustment is performed on the initial input data of the first pixel circuit, where the first pixel circuit and the second pixel circuit are located in the same pixel column.

The driving method for a display panel provided in the embodiment of the present disclosure is a preprocessing flow for a display image. In display applications of the display panel, an original display image signal is first processed to obtain multiple frames of to-be-displayed image. In this embodiment, the i-th frame of initial image is one frame of to-be-displayed image, or may also be any one of the obtained multiple frames of to-be-displayed image, where i is a positive integer greater than or equal to 1.

After receiving the i-th frame of initial image, the driving device applies the driving method for a display panel provided in the embodiment of the present disclosure to acquire initial input data of each pixel circuit in the i-th frame of initial image, and to acquire a target compensation value corresponding to each pixel circuit in the i-th frame of initial image. Based on the target compensation value of each pixel circuit, compensation adjustment is performed on the initial input data of each pixel circuit. A signal after the compensation adjustment is used as a data signal supplied by a respective data line to each pixel circuit. During the subsequent actual display of the i-th frame of initial image, the data signal supplied by the respective data line to each pixel circuit is the signal obtained after the compensation adjustment is performed on the initial input data based on the target compensation value of each pixel circuit. In this manner, the brightness uniformity of the display panel can be improved, the image quality and display effects of the display panel can be optimized, and the vertical crosstalk can be mitigated.

Specifically, when receiving the image data of the i-th frame of initial image, the driving device can acquire the initial input data corresponding to each pixel circuit of the display panel under the i-th frame of initial image according to the image data of the i-th frame of initial image. The initial input data corresponding to each pixel circuit under the i-th frame of initial image is the initial input data of each pixel circuit in the i-th frame of initial image. The driving device further extracts the reference compensation values corresponding to the pixel circuits in the i-th frame of initial image from a memory. It is to be understood that the display panel includes the memory in which a reference compensation value corresponding to each pixel circuit in the i-th frame of initial image is pre-stored. Based on this, according to the received image data of the i-th frame of initial image, the driving device obtains the initial input data of each pixel circuit in the i-th frame of initial image and the reference compensation value of each pixel circuit.

It is to be noted that the reference compensation values extracted by the driving device from the memory for the i-th frame of initial image may be a single value applied to each pixel circuit, that is, the reference compensation value corresponding to each pixel circuit in the i-th frame of initial image is the same. Alternatively, the reference compensation values extracted by the driving device from the memory for the i-th frame of initial image may be a set of reference compensation values. The set of reference compensation values includes a reference compensation value corresponding to each pixel-column group in the i-th frame of initial image, that is, each pixel-column group in the i-th frame of initial image corresponds to one reference compensation value, and reference compensation values corresponding to two different pixel-column groups may be the same or different. In this case, one pixel-column group includes at least one pixel column. Alternatively, the reference compensation values extracted by the driving device from the memory for the i-th frame of initial image may be a set of reference compensation values. The set of reference compensation values includes the reference compensation value corresponding to each pixel circuit in the i-th frame of initial image, that is, each pixel circuit in the i-th frame of initial image corresponds to one reference compensation value, and reference compensation values corresponding to two different pixel circuits may be the same or different. If i=1, the reference compensation value corresponding to each pixel circuit in the first frame of initial image may be 0, or may be a preset value. The process for obtaining the reference compensation values of the pixel circuits from the memory will be described in detail in various embodiments below and is therefore not repeated herein.

The first pixel circuit refers to any pixel circuit in the display panel, and the second pixel circuit also refers to any pixel circuit in the display panel. The second pixel circuit and the first pixel circuit are located in the same pixel column, and are located in different rows of the same pixel column. The first pixel circuit and the second pixel circuit that are located in the same pixel column are electrically connected to the same data line, the data line supplies a data signal to each pixel circuit electrically connected to the data line, and the data signal is a signal obtained after the compensation adjustment is performed on the initial input data.

In this embodiment, optionally, the first pixel circuit and the second pixel circuit are located in the same pixel column and are arranged adjacent to each other. Optionally, along a scanning direction of the display panel, the scanning process of the second pixel circuit precedes the scanning process of the first pixel circuit. Specifically, optionally, the display panel uses a row-by-row scanning mode. Along the scanning direction of the display panel, the same pixel column includes a pixel circuit of a (N−1)-th row and a pixel circuit of an N-th row, where the pixel circuit of the (N−1)-th row serves as the second pixel circuit, and the pixel circuit of the N-th row serves as the first pixel circuit, with N being greater than or equal to 1. During actual display, the scanning process of the second pixel circuit precedes the scanning process of the first pixel circuit. As shown in FIG. 1, optionally, the display panel performs scanning row by row along the F2 direction. Along the F2 direction, optionally, a pixel circuit 103b serves as the first pixel circuit, and correspondingly, a pixel circuit 103a, which is located in the same column and ahead of the first pixel circuit, is defined as the second pixel circuit. However, this is not limited herein. In other embodiments, optionally, along the scanning direction of the display panel, the same pixel column includes a pixel circuit of an (N−m)-th row and the pixel circuit of the N-th row, where m is greater than or equal to 1. The pixel circuit of the (N−m)-th row serves as the second pixel circuit, and the pixel circuit of the N-th row serves as the first pixel circuit, with N being greater than or equal to m.

According to the received image data of the i-th frame of initial image, the driving device acquires the initial input data of the first pixel circuit and the initial input data of the second pixel circuit, and can further extract the reference compensation value corresponding to the first pixel circuit in the i-th frame of initial image from the memory. By combining the initial input data of the first pixel circuit, the initial input data of the second pixel circuit, and the reference compensation value of the first pixel circuit, the target compensation value of the first pixel circuit can be calculated based on a preset calculation model (or a calculation program). The first pixel circuit is the any pixel circuit in the display panel. Similarly, according to the received image data of the i-th frame of initial image, the driving device can obtain the target compensation value corresponding to each pixel circuit in the i-th frame of initial image. It is to be understood that the memory of the display panel pre-stores the calculation model or calculation program that is used for calculating target compensation values of the pixel circuits. In the process of performing the driving method for a display panel, the driving device extracts the pre-stored calculation model from the memory and uses the calculation model to calculate the target compensation values of the pixel circuits.

According to the target compensation value of the first pixel circuit in the i-th frame of initial image, the driving device performs the compensation adjustment on the initial input data of the first pixel circuit to obtain a data signal of the first pixel circuit in the i-th frame of initial image. The data signal is obtained after the compensation adjustment is performed on the initial input data. When the driving device drives the display panel to display the i-th frame of initial image, a data line electrically connected to the first pixel circuit supplies the data signal to the first pixel circuit, where the data signal is obtained after the compensation adjustment is performed on the initial input data using the target compensation value. In this manner, the brightness uniformity of the display panel can be improved, the image quality and display effects of the display panel can be optimized, and the vertical crosstalk can be mitigated.

As described in the preceding, when the display panel actually displays the i-th frame of initial image, the data signal supplied by the data line to the first pixel circuit is not only associated with the initial input data of the first pixel circuit in the i-th frame of initial image, but also associated with initial input data of pixel circuits in different rows of the same pixel column, and further associated with the reference compensation values of the i-th frame of initial image. Due to the presence of the parasitic capacitance Cc in the pixel circuit, there is a current distribution difference among the multiple pixel circuits electrically connected to the same data line in the existing display panel. In this embodiment, the data signal supplied by the data line to the first pixel circuit is associated with the initial input data of the pixel circuits in the different rows of the same pixel column. In other words, the coupling influence among the pixel circuits in the different rows of the same pixel column is taken into account. Compared with the related art, this can reduce the current distribution difference among the multiple pixel circuits electrically connected to the same data line, thereby reducing voltage drop and/or voltage rising differences of the data line in the different regions. This can further reduce the fluctuations in the signals of the high-voltage power supply terminals PVDD among the multiple pixel circuits and the fluctuations in the signals of the low-voltage power supply terminals PVSS among the multiple pixel circuits. Ultimately, the brightness difference of the display panel in the different regions along the extending direction of the data line can be reduced, thereby improving the brightness consistency or uniformity of the display panel in the different regions along the extending direction of the data line.

In the present disclosure, the driving device for the display panel, according to the image data of the i-th frame of initial image, acquires the initial input data of the first pixel circuit in the i-th frame of initial image and the reference compensation value of the first pixel circuit, and further acquires the initial input data of the second pixel circuit that is located in the same pixel column as the first pixel circuit in the i-th frame of initial image; according to the reference compensation value of the first pixel circuit, the initial input data of the first pixel circuit, and the initial input data of the second pixel circuit, can determine the target compensation value of the first pixel circuit and perform the compensation adjustment on the initial input data of the first pixel circuit. Moreover, when the display panel displays the i-th frame of initial image, the data signal supplied by the data line to the first pixel circuit is obtained after the compensation adjustment is performed on the initial input data using the target compensation value. In the present disclosure, the data signal supplied by the data line to the first pixel circuit is associated with the initial input data of the pixel circuits in the different rows of the same pixel column. In this manner, adaptive compensation adjustment can be performed on the brightness of each light-emitting element based on the coupling influence of the pixel circuits in the different rows of the same pixel column. Therefore, the initial image is analyzed deeply and determined accurately through a display driving algorithm to provide compensation to the data signal supplied by the data line to the first pixel circuit. This can reduce the display brightness difference among the multiple pixel circuits electrically connected to the data line due to the coupling crosstalk, improve the brightness uniformity of the display panel in the extending direction of the data line, optimize the image quality and display effects of the display panel, and mitigate the vertical crosstalk.

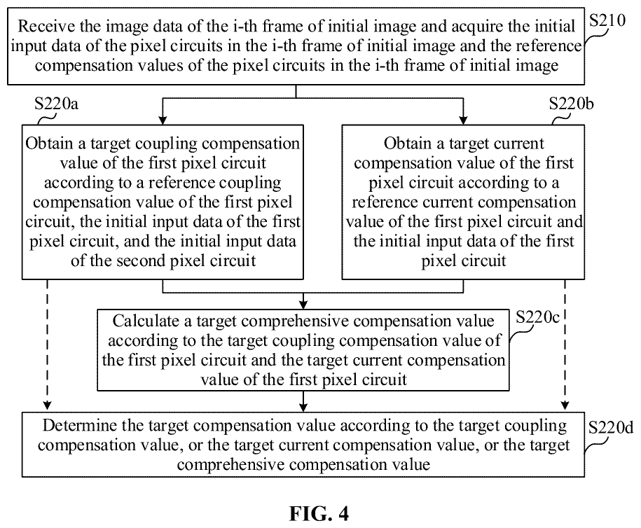

FIG. 4 is another diagram of a driving method for a display panel according to an embodiment of the present disclosure. As shown in FIG. 4, optionally, compensation values include at least one of a coupling compensation value or a current compensation value. The operation of determining the target compensation value of the first pixel circuit in S220 includes the steps below.

In S220a, a target coupling compensation value of the first pixel circuit is obtained according to a reference coupling compensation value of the first pixel circuit, the initial input data of the first pixel circuit, and the initial input data of the second pixel circuit.

In S220b, a target current compensation value of the first pixel circuit is obtained according to a reference current compensation value of the first pixel circuit and the initial input data of the first pixel circuit.

In S220c, a target comprehensive compensation value is calculated according to the target coupling compensation value of the first pixel circuit and the target current compensation value of the first pixel circuit.

In S220d, the target compensation value is determined according to the target coupling compensation value, or the target current compensation value, or the target comprehensive compensation value.

It is to be noted that, based on different display requirements of the display panel, the target coupling compensation value of the first pixel circuit may be determined as the target compensation value of the first pixel circuit, or the target current compensation value of the first pixel circuit may be determined as the target compensation value of the first pixel circuit, or the target comprehensive compensation value of the first pixel circuit may be determined as the target compensation value of the first pixel circuit. The following various embodiments are described using an example in which the target comprehensive compensation value of the first pixel circuit is used as the target compensation value of the first pixel circuit. Accordingly, in the subsequent description, the target compensation value refers to the target comprehensive compensation value obtained according to the target coupling compensation value of the first pixel circuit and the target current compensation value of the first pixel circuit, and such details will not be repeated.

It is to be understood that the memory of the display panel pre-stores a first calculation model for the pixel circuits, a second calculation model for the pixel circuits, and a third calculation model for the pixel circuits. The first calculation model is configured to calculate target coupling compensation values of the pixel circuits, the second calculation model is configured to calculate target current compensation values of the pixel circuits, and the third calculation model is configured to calculate target comprehensive compensation values of the pixel circuits. In the process of performing the driving method for a display panel, the driving device extracts the pre-stored first calculation model from the memory to calculate the target coupling compensation values of the pixel circuits, extracts the pre-stored second calculation model from the memory to calculate the target current compensation values of the pixel circuits, and extracts the pre-stored third calculation model from the memory to calculate the target comprehensive compensation values of the pixel circuits.

The process for acquiring the target coupling compensation values of the pixel circuits, the target current compensation values of the pixel circuits, and the target comprehensive compensation values of the pixel circuits is described in detail in various embodiments below.

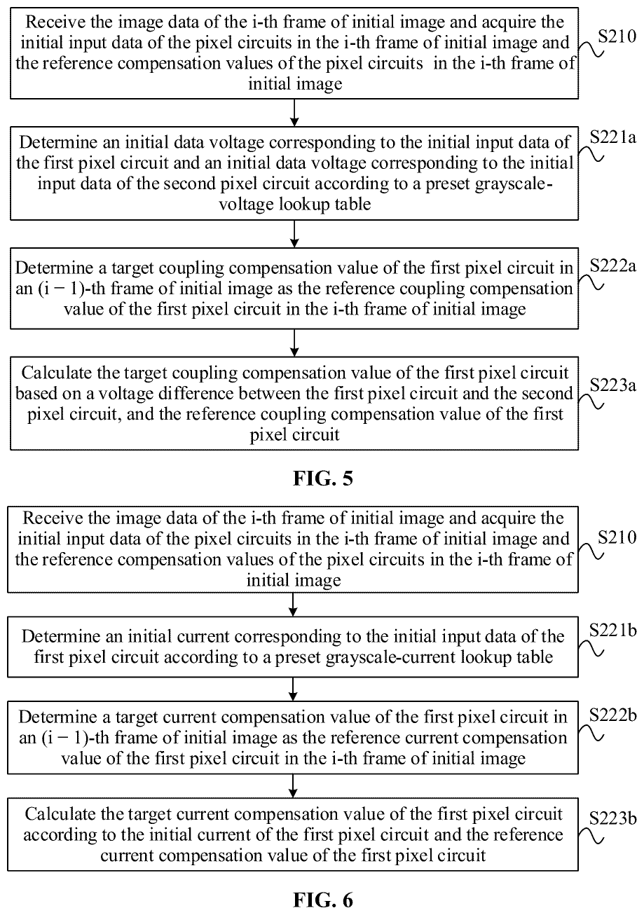

FIG. 5 is another diagram of a driving method for a display panel according to an embodiment of the present disclosure. As shown in FIG. 5, optionally, the operation of obtaining the target coupling compensation value of the first pixel circuit in S220a includes the steps below.

In S221a, an initial data voltage corresponding to the initial input data of the first pixel circuit and an initial data voltage corresponding to the initial input data of the second pixel circuit are determined according to a preset grayscale-voltage lookup table.

In S222a, a target coupling compensation value of the first pixel circuit in an (i−1)-th frame of initial image is determined as the reference coupling compensation value of the first pixel circuit in the i-th frame of initial image.

In S223a, the target coupling compensation value of the first pixel circuit is calculated based on a voltage difference between the first pixel circuit and the second pixel circuit, and the reference coupling compensation value of the first pixel circuit.

Optionally, calculating the target coupling compensation value of the first pixel circuit includes the following:

AVGa=[LM2Data×(V_Total−1)+ΔVt]/V_Total

AVGa denotes the target coupling compensation value of the first pixel circuit, LM2Data denotes the reference coupling compensation value of the first pixel circuit, V_Total denotes the row number of the first pixel circuit in the pixel column, and ΔVt denotes the voltage difference between the initial data voltage of the first pixel circuit and the initial data voltage of the second pixel circuit. AVGa=[LM2Data×(V_Total−1)+ΔVt]/V_Total is the first calculation model. The first calculation model is pre-stored in the memory of the display panel. The driving device calculates the target coupling compensation values AVGa of the pixel circuits in the i-th frame of initial image according to the first calculation model.

In this embodiment, when receiving the image data of the i-th frame of initial image, the driving device can obtain the initial input data of each pixel circuit according to the image data of the i-th frame of initial image. In this case, optionally, the initial input data of each pixel circuit in the i-th frame of initial image includes a grayscale value of each pixel circuit.

It is to be understood that the grayscale-voltage lookup table is pre-stored in the memory of the display panel. The grayscale-voltage lookup table includes multiple grayscale values and data voltages corresponding to the grayscale values. Based on this, after obtaining the initial input data of the first pixel circuit according to the image data of the i-th frame of initial image, the driving device looks up a data voltage corresponding to the initial input data of the first pixel circuit from the grayscale-voltage lookup table. This data voltage serves as the initial data voltage corresponding to the initial input data of the first pixel circuit in the i-th frame of initial image. Similarly, the driving device obtains the initial data voltage corresponding to the initial input data of the second pixel circuit in the i-th frame of initial image based on the grayscale-voltage lookup table. The driving device then calculates the voltage difference ΔVt between the initial data voltage of the first pixel circuit and the initial data voltage of the second pixel circuit. In the case required by a product, the voltage difference ΔVt is the initial data voltage of the first pixel circuit minus the initial data voltage of the second pixel circuit, or the initial data voltage of the second pixel circuit minus the initial data voltage of the first pixel circuit, which is not specifically limited.

Optionally, the memory of the display panel includes a first-row memory, and the first-row memory includes multiple storage units; one storage unit is configured to store a target coupling compensation value corresponding to one frame of initial image. Prior to the i-th frame of initial image, when receiving the (i−1)-th frame of initial image, the driving device obtains a target coupling compensation value of each pixel circuit in the (i−1)-th frame of initial image based on the driving method for a display panel and then specifically stores the target coupling compensation value in an (i−1)-th storage unit allocated to the (i−1)-th frame of initial image in the first-row memory. Based on this, according to the i-th frame of initial image, the driving device extracts the pre-stored target coupling compensation value of the first pixel circuit in the (i−1)-th frame of initial image from the (i−1)-th storage unit of the first-row memory and uses the target coupling compensation value as the reference coupling compensation value LM2Data of the first pixel circuit in the i-th frame of initial image, which is then applied in the first calculation model.

When receiving the i-th frame of initial image, the driving device already knows the row number V_Total of the first pixel circuit in the pixel column along the scanning direction of the display panel. Using the pixel circuit of the N-th row of the pixel column along the scanning direction of the display panel being the first pixel circuit as an example, V_Total=N. The driving device also calculates the voltage difference ΔVt between the first pixel circuit and the second pixel circuit in the i-th frame of initial image. The driving device also extracts the reference coupling compensation value LM2Data of the first pixel circuit in the i-th frame of initial image from the first-row memory. By substituting values of the preceding parameters into the first calculation model, the driving device can obtain the target coupling compensation value AVGa of the first pixel circuit in the i-th frame of initial image. Based on this, optionally, the target coupling compensation value of the first pixel circuit in the i-th frame of initial image is stored in a storage unit of the first-row memory that is disposed corresponding to the i-th frame of initial image. In this manner, the driving device can use the target coupling compensation value of the first pixel circuit in the i-th frame of initial image as a reference coupling compensation value of the first pixel circuit in the next frame of initial image, that is, an (i+1)-th frame of initial image.

As described in the preceding, along the scanning direction of the display panel, optionally, the pixel circuit of the N-th row of the pixel column is regarded as the first pixel circuit. In this case, [LM2Data×(V_Total−1)+ΔVt] may be understood as accumulated coupling values experienced by the data line over first N rows of one frame of initial image. Accordingly, the target coupling compensation value AVGa of the first pixel circuit in the i-th frame of initial image may be understood as the average of the accumulated coupling values experienced by the data line over the first N rows of the one frame of initial image. It is to be noted that, if N=1, optionally, ΔVt is 0.

In this embodiment, the target compensation value of the first pixel circuit in the i-th frame of initial image is obtained based on the target coupling compensation value of the first pixel circuit. When the display panel actually displays the i-th frame of initial image, the data signal supplied by the data line to the first pixel circuit is associated with initial data voltages of the pixel circuits in the different rows of the same pixel column, that is, the coupling influence of the pixel circuits in the different rows of the same pixel column is taken into account, and is also associated with the coupling value of the same pixel circuit in the previous frame of initial image, that is, the coupling influence of the previous frame of initial image on the same pixel circuit is considered. Therefore, the current distribution difference among the pixel circuits that are located in the different rows and are electrically connected to the same data line can be reduced, further decreasing voltage drop and/or voltage rising differences of the data line among the pixel circuits in the different rows. This can further reduce the fluctuations in the signals of the high-voltage power supply terminals PVDD among the multiple pixel circuits and the fluctuations in the signals of the low-voltage power supply terminals PVSS among the multiple pixel circuits. Ultimately, the brightness difference of the display panel in the different regions along the extending direction of the data line can be reduced, thereby improving the brightness consistency or uniformity of the display panel in the different regions along the extending direction of the data line, optimizing the image quality and display effects of the display panel, and mitigating the vertical crosstalk.

FIG. 6 is another diagram of a driving method for a display panel according to an embodiment of the present disclosure. As shown in FIG. 6, optionally, the operation of obtaining the target current compensation value of the first pixel circuit in S220b includes the steps below.

In S221b, an initial current corresponding to the initial input data of the first pixel circuit is determined according to a preset grayscale-current lookup table.

In S222b, a target current compensation value of the first pixel circuit in an (i−1)-th frame of initial image is determined as the reference current compensation value of the first pixel circuit in the i-th frame of initial image.

In S223b, the target current compensation value of the first pixel circuit is calculated according to the initial current of the first pixel circuit and the reference current compensation value of the first pixel circuit.

Optionally, calculating the target current compensation value of the first pixel circuit includes the following:

AVGb=[LM3Data×(V_Total−1)+It]/V_Total

AVGb denotes the target current compensation value of the first pixel circuit, LM3Data denotes the reference current compensation value of the first pixel circuit, V_Total denotes the row number of the first pixel circuit in the pixel column, and It denotes the initial current of the first pixel circuit. The second calculation model is AVGb=[LM3Data×(V_Total−1)+It]/V_Total. The second calculation model is pre-stored in the memory of the display panel. The driving device calculates the target current compensation values AVGb of the pixel circuits in the i-th frame of initial image according to the second calculation model.

In this embodiment, optionally, the initial input data of each pixel circuit includes a grayscale value of each pixel circuit.

The grayscale-current lookup table is pre-stored in the memory of the display panel. The grayscale-current lookup table includes multiple grayscale values and current values corresponding to the grayscale values. Based on this, after obtaining the initial input data of the first pixel circuit according to the image data of the i-th frame of initial image, the driving device looks up a current value corresponding to the initial input data of the first pixel circuit from the grayscale-current lookup table. This current value serves as the initial current It corresponding to the initial input data of the first pixel circuit in the i-th frame of initial image.

Optionally, the memory of the display panel includes a second-row memory, and the second-row memory includes multiple storage units; one storage unit is configured to store a target current compensation value corresponding to one frame of initial image. Prior to the i-th frame of initial image, when receiving the (i−1)-th frame of initial image, the driving device obtains a target current compensation value of each pixel circuit in the (i−1)-th frame of initial image based on the driving method for a display panel and then specifically stores the target current compensation value in an (i−1)-th storage unit allocated to the (i−1)-th frame of initial image in the second-row memory. Based on this, according to the i-th frame of initial image, the driving device extracts the pre-stored target current compensation value of the first pixel circuit in the (i−1)-th frame of initial image from the (i−1)-th storage unit of the second-row memory and uses the target current compensation value as the reference current compensation value LM3Data of the first pixel circuit in the i-th frame of initial image, which is then applied in the second calculation model.

When receiving the i-th frame of initial image, the driving device already knows the row number V_Total of the first pixel circuit in the pixel column along the scanning direction of the display panel. Using the pixel circuit of the N-th row of the pixel column along the scanning direction of the display panel being the first pixel circuit as an example, V_Total=N.

As described in the preceding, after obtaining LM3Data, V_Total, and It that correspond to the first pixel circuit in the i-th frame of initial image, the driving device substitutes values of the preceding parameters into the second calculation model, thereby obtaining the target current compensation value AVGb of the first pixel circuit in the i-th frame of initial image. Based on this, optionally, the target current compensation value of the first pixel circuit in the i-th frame of initial image is stored in a storage unit of the second-row memory that is disposed corresponding to the i-th frame of initial image. In this manner, the driving device can use the target current compensation value of the first pixel circuit in the i-th frame of initial image as a reference current compensation value of the first pixel circuit in the next frame of initial image, that is, an (i+1)-th frame of initial image.

As described in the preceding, along the scanning direction of the display panel, optionally, the pixel circuit of the N-th row of the pixel column is regarded as the first pixel circuit. In this case, [LM3Data×(V_Total−1)+It] may be understood as accumulated current values experienced by the data line over first N rows of one frame of initial image. Accordingly, the target current compensation value AVGb of the first pixel circuit in the i-th frame of initial image may be understood as the average of the accumulated current values experienced by the data line over the first N rows of the one frame of initial image.

In this embodiment, the target compensation value of the first pixel circuit in the i-th frame of initial image is obtained based on the target current compensation value of the first pixel circuit. When the display panel actually displays the i-th frame of initial image, the data signal supplied by the data line to the first pixel circuit is associated with the current compensation value of the same pixel circuit in the previous frame of initial image. In other words, the coupling influence of the previous frame of initial image on the same pixel circuit is taken into account. Therefore, the current distribution difference among the pixel circuits that are located in the different rows and are connected to the same data line can be reduced, thereby decreasing the brightness difference of the display panel in the different regions along the extending direction of the data line. This can improve the brightness consistency or uniformity of the display panel in the different regions along the extending direction of the data line, optimize the image quality and display effects of the display panel, and mitigate the vertical crosstalk.

Referring to FIGS. 4, 5, and 6, optionally, the operation of calculating the target comprehensive compensation value in S220c includes the following:

AVGc=AVGa×ka+AVGb×kb

AVGc denotes the target comprehensive compensation value, AVGa denotes the target coupling compensation value of the first pixel circuit, AVGb denotes the target current compensation value of the first pixel circuit, ka denotes a compensation coefficient of the target coupling compensation value, and kb denotes a compensation coefficient of the target current compensation value. Optionally, 0≤ka≤2, and 0≤kb≤2. Optionally, ka=kb=1. The third calculation model is AVGc=AVGa×ka+AVGb×kb. The third calculation model is pre-stored in the memory of the display panel. The driving device calculates the target comprehensive compensation values AVGc of the pixel circuits in the i-th frame of initial image according to the third calculation model. The relevant practitioners may reasonably design the specific values of ka and kb according to requirements of the product. The values of ka and kb may be the same or different, and are not specifically limited. ka=kb=1 is used as an example in this embodiment.

As described in the preceding, when receiving the i-th frame of initial image, the driving device calculates the target coupling compensation value of the first pixel circuit in the i-th frame of initial image according to the first calculation model, calculates the target current compensation value of the first pixel circuit in the i-th frame of initial image according to the second calculation model, and then calculates the target comprehensive compensation value of the first pixel circuit in the i-th frame of initial image according to the third calculation model. The driving device determines the target comprehensive compensation value as the target compensation value of the first pixel circuit in the i-th frame of initial image. Based on this, when the display panel actually displays the i-th frame of initial image, the data signal supplied by the data line to the first pixel circuit takes into account both the coupling influence from the pixel circuits in the different rows of the same pixel column and the coupling influence from the previous frame of initial image so that the brightness difference of the display panel in the different regions in the extending direction of the data line can be reduced, the brightness consistency or uniformity of the display panel in the different region in the extending direction of the data line can be improved, and the image quality and display effects of the display panel can be optimized, thereby mitigating the vertical crosstalk.

It is to be noted that the lookup manner of the preceding grayscale-voltage lookup table and grayscale-current lookup table essentially involves converting the initial input data of each pixel circuit into a corresponding level signal, and then converting the level signal of the initial input data into another numerical value through a fixed lookup table. Optionally, the first-row memory of the display panel may include multiple storage units for storing red R data and blue B data and multiple storage units for storing green G data. Similarly, the second-row memory of the display panel may include multiple storage units for storing red R data and blue B data and multiple storage units for storing green G data. Certainly, data of multiple different colors in one frame of initial image may also be stored in the same storage unit, which is not specifically limited. It is to be further noted that the first calculation model, the second calculation model, and the third calculation model that are described in the preceding provide corresponding logical computation concepts. In actual implementation, data analysis and processing may be required to complete calculations. For example, in the process of calculating the target coupling compensation value, the target current compensation value, or the target comprehensive compensation value, multiple pieces of data may be converted into display brightness levels DBV before being substituted into the calculation models to facilitate the calculations. The specific process is not repeated herein.

As described in the preceding embodiments, the memory of the display panel includes the first-row memory and the second-row memory. The first-row memory includes at least one storage unit. A respective storage unit is configured to store a target coupling compensation value corresponding to each pixel circuit in one frame of initial image. The second-row memory includes at least one storage unit. A respective storage unit is configured to store a target current compensation value corresponding to each pixel circuit in the one frame of initial image. As the size of the display panel increases, and the resolution of the display panel improves, the number of pixel circuits in the display panel grows significantly. As a result, the memory occupied by the first-row memory and the second-row memory becomes large, which would adversely affect the performance of an electronic device.

Based on this, optionally, the driving method for a display panel further includes: calculating a target coupling compensation average value of multiple pixel circuits in one pixel-column group in the i-th frame of initial image, storing a target coupling compensation average value of a pixel-column group in which the first pixel circuit is located, and using the stored target coupling compensation average value as a reference coupling compensation value of the first pixel circuit in the next frame of initial image. Specifically, the driving device can calculate a target coupling compensation value of each pixel circuit in the i-th frame of initial image according to the first calculation model. Using the one pixel-column group including one pixel column as an example, the driving device sums target coupling compensation values of multiple pixel circuits in the one pixel column and then calculates the average value of the summed target coupling compensation values, so as to obtain a target coupling compensation average value corresponding to the one pixel column. A target coupling compensation average value of each pixel-column group in the i-th frame of initial image is stored in a respective storage unit of the first-row memory. Sequentially, when receiving the (i+1)-th frame of initial image, the driving device extracts the target coupling compensation average value of the pixel-column group in which the first pixel circuit in the i-th frame of initial image is located, from the first-row memory. The target coupling compensation average value is used as the reference coupling compensation value of the first pixel circuit in the (i+1)-th frame of initial image. In other words, the target coupling compensation average value corresponding to the one pixel-column group is uniformly used as a reference coupling compensation value of each pixel circuit in the one pixel-column group in the next frame of initial image. Apparently, one storage unit of the first-row memory only needs to store a target coupling compensation average value corresponding to multiple pixel-column groups of the one frame of initial image. This can significantly reduce the memory occupied by the first-row memory.

Similarly, optionally, the driving method for a display panel further includes: calculating a target current compensation average value of the multiple pixel circuits in the one pixel-column group in the i-th frame of initial image, storing a target current compensation average value of the pixel-column group in which the first pixel circuit is located, and using the stored target current compensation average value as a reference current compensation value of the first pixel circuit in the next frame of initial image. Specifically, the driving device can calculate a target current compensation value of each pixel circuit in the i-th frame of initial image according to the second calculation model. Using the one pixel-column group including the one pixel column as an example, the driving device sums target current compensation values of multiple pixel circuits in the one pixel column and then calculates the average value of the summed target current compensation values, so as to obtain the target current compensation average value corresponding to the one pixel column. A target current compensation average value of each pixel-column group in the i-th frame of initial image is stored in a respective storage unit of the second-row memory. Sequentially, when receiving the (i+1)-th frame of initial image, the driving device extracts the target current compensation average value of the pixel-column group in which the first pixel circuit in the i-th frame of initial image is located, from the second-row memory. The target current compensation average value is used as the reference current compensation value of the first pixel circuit in the (i+1)-th frame of initial image. In other words, the target current compensation average value corresponding to the one pixel-column group is uniformly used as a reference current compensation value of each pixel circuit in the one pixel-column group in the next frame of initial image. Apparently, one storage unit of the second-row memory only needs to store a target current compensation average value corresponding to the multiple pixel-column groups of the one frame of initial image. This can significantly reduce the memory occupied by the second-row memory.

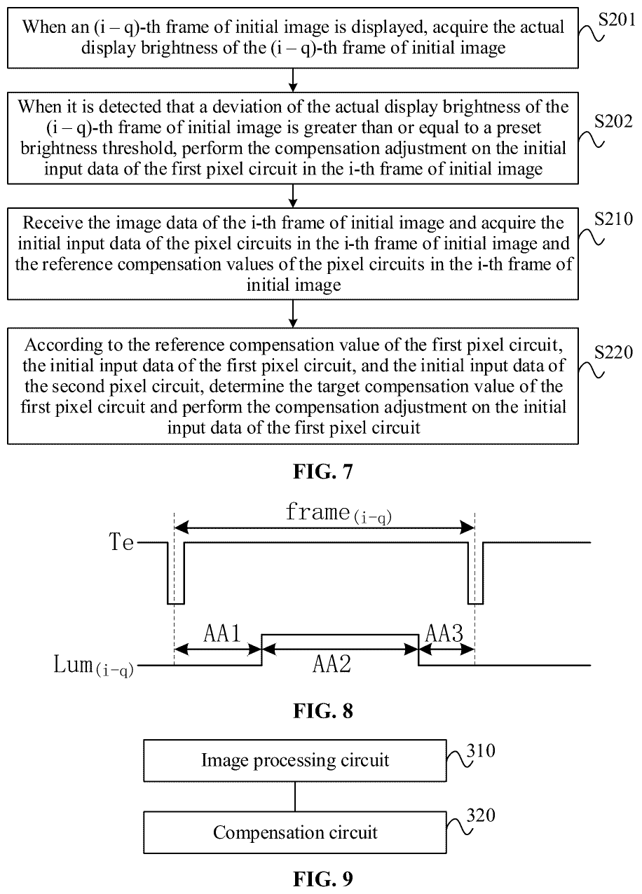

FIG. 7 is another diagram of a driving method for a display panel according to an embodiment of the present disclosure. FIG. 8 is a diagram of the brightness of a display panel according to an embodiment of the present disclosure. As shown in FIGS. 7 and 8, optionally, the compensation procedure of the display panel has a triggering mechanism. Specifically, optionally, the driving method for a display panel further includes the steps below.

In S201, when an (i−q)-th frame of initial image is displayed, the actual display brightness of the (i−q)-th frame of initial image is acquired, where q is greater than or equal to 1.

In S202, when it is detected that a deviation of the actual display brightness of the (i−q)-th frame of initial image is greater than or equal to a preset brightness threshold, the compensation adjustment is performed on the initial input data of the first pixel circuit in the i-th frame of initial image.

In conjunction with FIGS. 7 and 8, optionally, the (i−q)-th frame of initial image is a solid-color image. The waveform of Lmu_{(i-q)} shown in FIG. 8 represents the acquired actual display brightness of the display panel when the display panel actually displays the (i−q)-th frame of initial image (frame_{(i-q)}). Specifically, it represents the actual display brightness Lmu_{(i-q)} in the different regions of the display panel. The display brightness of a display sub-region AA1 and the display brightness of a display sub-region AA3 in the display panel may be increased or decreased due to the coupling influence of a display sub-region AA2, that is, crosstalk occurs in the display panel. In other words, the actual display brightness Lmu_{(i-q)} of the display panel in the different regions is subjected to a deviation. It is to be noted that, with reference to FIG. 1, the display sub-region AA1, the display sub-region AA2, and the display sub-region AA3 in the display panel may be arranged sequentially along the F2 direction, or may be arranged sequentially along the F1 direction, which is not specifically limited.

The memory of the display panel pre-stores the preset brightness threshold. Based on the waveform of the actual display brightness Lmu_{(i-q)} of the display panel, the driving device can obtain the maximum value and minimum value of the actual display brightness of the (i−q)-th frame of initial image. The difference between the maximum value of the actual display brightness of the (i−q)-th frame of initial image and the minimum value of the actual display brightness of the (i−q)-th frame of initial image is determined as the deviation of the actual display brightness. The driving device detects whether the deviation of the actual display brightness of the (i−q)-th frame of initial image is greater than or equal to the preset brightness threshold. If detecting that the deviation of the actual display brightness of the (i−q)-th frame of initial image is greater than or equal to the preset brightness threshold, the driving device enters the compensation procedure upon receiving the i-th frame of initial image, thereby performing the compensation adjustment on the initial input data of the first pixel circuit in the i-th frame of initial image. Optionally, the value of q is less than or equal to the value of the refresh rate of the display panel. Exemplarily, if the refresh rate of the display panel is 120 Hz, q is optionally less than or equal to 120.

Based on the same inventive concept, an embodiment of the present disclosure further provides a driving device for a display panel. The driving device can be used to perform the driving method provided in any embodiment of the present disclosure and has functional circuits and beneficial effects that correspond to the performed method. FIG. 9 is a diagram of a driving device for a display panel according to an embodiment of the present disclosure. As shown in FIG. 9, the driving device includes an image processing circuit 310 and a compensation circuit 320. The image processing circuit 310 is configured to receive image data of an i-th frame of initial image, and acquire initial input data of pixel circuits in the i-th frame of initial image and reference compensation values of the pixel circuits in the i-th frame of initial image. The compensation circuit 320 is configured to, according to a reference compensation value of a first pixel circuit, initial input data of the first pixel circuit, and initial input data of a second pixel circuit, determine a target compensation value of the first pixel circuit and perform compensation adjustment on the initial input data of the first pixel circuit. The first pixel circuit and the second pixel circuit are located in the same pixel column.

Optionally, the first pixel circuit and the second pixel circuit are located in the same pixel column and are arranged adjacent to each other. Optionally, along a scanning direction of the display panel, the scanning process of the second pixel circuit precedes the scanning process of the first pixel circuit.

Optionally, compensation values include at least one of a coupling compensation value or a current compensation value. Correspondingly, the compensation circuit 320 performs the operation of determining the target compensation value of the first pixel circuit: obtaining a target coupling compensation value of the first pixel circuit according to a reference coupling compensation value of the first pixel circuit, the initial input data of the first pixel circuit, and the initial input data of the second pixel circuit; obtaining a target current compensation value of the first pixel circuit according to a reference current compensation value of the first pixel circuit and the initial input data of the first pixel circuit; calculating a target comprehensive compensation value according to the target coupling compensation value of the first pixel circuit and the target current compensation value of the first pixel circuit; and determining the target compensation value according to the target coupling compensation value, or the target current compensation value, or the target comprehensive compensation value.

Optionally, the compensation circuit 320 performs the operation of obtaining the target coupling compensation value of the first pixel circuit: determining an initial data voltage corresponding to the initial input data of the first pixel circuit and an initial data voltage corresponding to the initial input data of the second pixel circuit according to a preset grayscale-voltage lookup table; determining a target coupling compensation value of the first pixel circuit in an (i−1)-th frame of initial image as the reference coupling compensation value of the first pixel circuit in the i-th frame of initial image; and calculating the target coupling compensation value of the first pixel circuit based on a voltage difference between the first pixel circuit and the second pixel circuit, and the reference coupling compensation value of the first pixel circuit. Optionally, the compensation circuit 320 performs the operation of calculating the target coupling compensation value of the first pixel circuit:

AVGa=[LM2Data×(V_Total−1)+ΔVt]/V_Total

AVGa denotes the target coupling compensation value of the first pixel circuit, LM2Data denotes the reference coupling compensation value of the first pixel circuit, V_Total denotes the row number of the first pixel circuit in the pixel column, and ΔVt denotes the voltage difference between the initial data voltage of the first pixel circuit and the initial data voltage of the second pixel circuit.

Optionally, the compensation circuit 320 performs the operation of obtaining the target current compensation value of the first pixel circuit: determining an initial current corresponding to the initial input data of the first pixel circuit according to a preset grayscale-current lookup table; determining a target current compensation value of the first pixel circuit in an (i−1)-th frame of initial image as the reference current compensation value of the first pixel circuit in the i-th frame of initial image; and calculating the target current compensation value of the first pixel circuit according to the initial current of the first pixel circuit and the reference current compensation value of the first pixel circuit. Optionally, the compensation circuit 320 performs the operation of calculating the target current compensation value of the first pixel circuit: AVGb=[LM3Data×(V_Total−1)+It]/V_Total, where AVGb denotes the target current compensation value of the first pixel circuit, LM3Data denotes the reference current compensation value of the first pixel circuit, V_Total denotes the row number of the first pixel circuit in the pixel column, and It denotes the initial current of the first pixel circuit.

Optionally, the compensation circuit 320 performs the operation of calculating the target comprehensive compensation value: AVGc=AVGa×ka+AVGb×kb, where AVGc denotes the target comprehensive compensation value, AVGa denotes the target coupling compensation value of the first pixel circuit, AVGb denotes the target current compensation value of the first pixel circuit, ka denotes a compensation coefficient of the target coupling compensation value, and kb denotes a compensation coefficient of the target current compensation value. Optionally, 0≤ka≤2, and 0≤kb≤2. Optionally, ka=kb=1. Optionally, the driving device for a display panel further includes a first-row memory and a second-row memory. The first-row memory is configured to store the target coupling compensation value of the first pixel circuit in the i-th frame of initial image in a storage unit of the first-row memory that is disposed corresponding to the i-th frame of initial image. The second-row memory is configured to store the target current compensation value of the first pixel circuit in the i-th frame of initial image in a storage unit of the second-row memory that is disposed corresponding to the i-th frame of initial image.

Optionally, the driving device for a display panel further includes a calculation circuit. The calculation circuit is configured to calculate a target coupling compensation average value of multiple pixel circuits in one pixel-column group in the i-th frame of initial image, store a target coupling compensation average value of a pixel-column group in which the first pixel circuit is located, in the first-row memory, and use the stored target coupling compensation average value as a reference coupling compensation value of the first pixel circuit in the next frame of initial image. The calculation circuit is further configured to calculate a target current compensation average value of the multiple pixel circuits in the one pixel-column group in the i-th frame of initial image, store a target current compensation average value of the pixel-column group in which the first pixel circuit is located, in the second-row memory, and use the stored target current compensation average value as a reference current compensation value of the first pixel circuit in the next frame of initial image. The one pixel-column group includes at least one pixel column or may include multiple pixel columns adjacent.

In the present disclosure, a data signal supplied by a data line to the first pixel circuit is associated with initial input data of pixel circuits in different rows of the same pixel column. In this manner, adaptive compensation adjustment can be performed on the brightness of each light-emitting element based on the coupling influence of the pixel circuits in the different rows of the same pixel column. Therefore, by cumulatively calculating data in one frame of initial image, the possible degree of a brightness deviation (C/T) can be predicted. On this basis, precise additive or subtractive compensation can be applied to the data signal output by the data line. This can reduce the display brightness difference among multiple pixel circuits electrically connected to the data line due to coupling crosstalk, improve brightness uniformity of the display panel in the extending direction of the data line, optimize image quality and display effects of the display panel, and mitigate vertical crosstalk.

Based on the same inventive concept, an embodiment of the present disclosure further provides a display panel. Referring to FIG. 1, the display panel includes multiple pixel columns 101, multiple data lines 102, and the driving device (not shown). A pixel column 101 of the multiple pixel columns 101 includes multiple pixel circuits 103, and the multiple pixel circuits 103 are electrically connected to the same data line 102. The driving device is electrically connected to the data lines 102 and is configured to supply compensated data signals to the data lines 102.

In this embodiment, the display panel includes the driving device provided in any embodiment of the present disclosure. The driving device is configured to perform the driving method provided in any embodiment of the present disclosure and has functional circuits and beneficial effects that correspond to the performed method. Herein, the display panel may be applied to an electronic device such as a mobile phone, a computer, a smart wearable device (for example, a smartwatch), and an in-vehicle display device, which is not limited in the embodiment of the present disclosure. Optionally, the display panel is an organic light-emitting display panel, which is not limited herein.

In the present disclosure, the data signal supplied by the data line to the first pixel circuit is associated with the initial input data of the pixel circuits in the different rows of the same pixel column. In this manner, the adaptive compensation adjustment can be performed on the brightness of each light-emitting element based on the coupling influence of the pixel circuits in the different rows of the same pixel column. Therefore, this can reduce the display brightness difference among the multiple pixel circuits electrically connected to the data line due to the coupling crosstalk, improve the brightness uniformity of the display panel in the extending direction of the data line, optimize the image quality and display effects of the display panel, and mitigate the vertical crosstalk. To address the vertical crosstalk of the display panel, the display effects of the display panel can be optimized through an algorithm, thereby reducing dependence on the display panel technology. This can avoid the limitations in the improvement of the display panel technology. The image quality of the display panel can be improved through the display driving algorithm so that the visual effects of the display panel can be improved, and the crosstalk of the display panel in the vertical direction can be mitigated.

It is to be understood that various forms of processes shown in the preceding may be adopted with steps reordered, added, or deleted. For example, the steps described in the present disclosure may be performed in parallel, sequentially, or in different sequences, as long as the desired results of the technical solutions of the present disclosure can be achieved, and no limitation is imposed herein.

The preceding embodiments do not limit the scope of the present disclosure. It is to be understood by those skilled in the art that various modifications, combinations, sub-combinations, and substitutions may be made according to design requirements and other factors. Any modification, equivalent substitution, improvement, or the like that is made within the spirit and principle of the present disclosure is within the scope of the present disclosure.

What is claimed is:

1. A driving method for a display panel, wherein the display panel comprises a plurality of pixel columns and a plurality of data lines, a pixel column of the plurality of pixel columns comprises a plurality of pixel circuits, and the plurality of pixel circuits are electrically connected to a same data line of the plurality of data lines; and
the driving method comprises:
receiving image data of an i-th frame of initial image, and acquiring initial input data of pixel circuits in the i-th frame of initial image and reference compensation values of the pixel circuits in the i-th frame of initial image; and
according to a reference compensation value of a first pixel circuit, initial input data of the first pixel circuit, and initial input data of a second pixel circuit, determining a target compensation value of the first pixel circuit and performing compensation adjustment on the initial input data of the first pixel circuit,
wherein the first pixel circuit and the second pixel circuit are located in a same pixel column of the plurality of pixel columns.

2. The driving method according to claim 1, wherein the first pixel circuit and the second pixel circuit are located in the same pixel column and are arranged adjacent to each other.

3. The driving method according to claim 2, wherein along a scanning direction of the display panel, a scanning process of the second pixel circuit precedes a scanning process of the first pixel circuit.

4. The driving method according to claim 1, wherein compensation values comprise at least one of a coupling compensation value or a current compensation value; and
determining the target compensation value of the first pixel circuit comprises:
obtaining a target coupling compensation value of the first pixel circuit according to a reference coupling compensation value of the first pixel circuit, the initial input data of the first pixel circuit, and the initial input data of the second pixel circuit;
obtaining a target current compensation value of the first pixel circuit according to a reference current compensation value of the first pixel circuit and the initial input data of the first pixel circuit;
calculating a target comprehensive compensation value according to the target coupling compensation value of the first pixel circuit and the target current compensation value of the first pixel circuit; and
determining the target compensation value according to the target coupling compensation value, or the target current compensation value, or the target comprehensive compensation value.

5. The driving method according to claim 4, wherein obtaining the target coupling compensation value of the first pixel circuit comprises:
determining an initial data voltage corresponding to the initial input data of the first pixel circuit and an initial data voltage corresponding to the initial input data of the second pixel circuit according to a preset grayscale-voltage lookup table;
determining a target coupling compensation value of the first pixel circuit in an (i−1)-th frame of initial image as the reference coupling compensation value of the first pixel circuit in the i-th frame of initial image; and
calculating the target coupling compensation value of the first pixel circuit based on a voltage difference between the first pixel circuit and the second pixel circuit, and the reference coupling compensation value of the first pixel circuit.

6. The driving method according to claim 5, wherein calculating the target coupling compensation value of the first pixel circuit comprises:
AVGa=[LM2Data×(V_Total−1)+ΔVt]/V_Total,
wherein AVGa denotes the target coupling compensation value of the first pixel circuit, LM2Data denotes the reference coupling compensation value of the first pixel circuit, V_Total denotes a row number of the first pixel circuit in the pixel column, and ΔVt denotes a voltage difference between the initial data voltage of the first pixel circuit and the initial data voltage of the second pixel circuit.

7. The driving method according to claim 4, wherein obtaining the target current compensation value of the first pixel circuit comprises:
determining an initial current corresponding to the initial input data of the first pixel circuit according to a preset grayscale-current lookup table;
determining a target current compensation value of the first pixel circuit in an (i−1)-th frame of initial image as the reference current compensation value of the first pixel circuit in the i-th frame of initial image; and
calculating the target current compensation value of the first pixel circuit according to the initial current of the first pixel circuit and the reference current compensation value of the first pixel circuit.

8. The driving method according to claim 7, wherein calculating the target current compensation value of the first pixel circuit comprises:
AVGb=[LM3Data×(V_Total−1)+It]/V_Total,
wherein AVGb denotes the target current compensation value of the first pixel circuit, LM3Data denotes the reference current compensation value of the first pixel circuit, V_Total denotes a row number of the first pixel circuit in the pixel column, and It denotes the initial current of the first pixel circuit.

9. The driving method according to claim 4, wherein calculating the target comprehensive compensation value comprises:
AVGc=AVGa×ka+AVGb×kb,
wherein AVGc denotes the target comprehensive compensation value, AVGa denotes the target coupling compensation value of the first pixel circuit, AVGb denotes the target current compensation value of the first pixel circuit, ka denotes a compensation coefficient of the target coupling compensation value, and kb denotes a compensation coefficient of the target current compensation value.

10. The driving method according to claim 9, wherein 0≤ka≤2, and 0≤kb≤2.

11. The driving method according to claim 9, wherein ka=kb=1.

12. The driving method according to claim 4, further comprising:
storing the target coupling compensation value of the first pixel circuit in the i-th frame of initial image in a storage unit of a first-row memory that is disposed corresponding to the i-th frame of initial image; and
storing the target current compensation value of the first pixel circuit in the i-th frame of initial image in a storage unit of a second-row memory that is disposed corresponding to the i-th frame of initial image.

13. The driving method according to claim 4, further comprising:
calculating a target coupling compensation average value of a plurality of pixel circuits in one pixel-column group in the i-th frame of initial image, storing a target coupling compensation average value of a pixel-column group in which the first pixel circuit is located, and using the stored target coupling compensation average value as a reference coupling compensation value of the first pixel circuit in a next frame of initial image; and
calculating a target current compensation average value of the plurality of pixel circuits in the one pixel-column group in the i-th frame of initial image, storing a target current compensation average value of the pixel-column group in which the first pixel circuit is located, and using the stored target current compensation average value as a reference current compensation value of the first pixel circuit in the next frame of initial image,
wherein the one pixel-column group comprises at least one pixel column.

14. The driving method according to claim 1, further comprising:
when an (i−q)-th frame of initial image is displayed, acquiring an actual display brightness of the (i−q)-th frame of initial image, wherein q is greater than or equal to 1; and
when it is detected that a deviation of the actual display brightness of the (i−q)-th frame of initial image is greater than or equal to a preset brightness threshold, performing the compensation adjustment on the initial input data of the first pixel circuit in the i-th frame of initial image.

15. A driving device for a display panel, wherein the display panel comprises a plurality of pixel columns and a plurality of data lines, a pixel column of the plurality of pixel columns comprises a plurality of pixel circuits, and the plurality of pixel circuits are electrically connected to a same data line of the plurality of data lines; and
the driving device comprises a processor and a storage device, wherein the storage device stores processor-executable programs, and the programs comprise:
an image processing circuit configured to receive image data of an i-th frame of initial image, and acquire initial input data of pixel circuits in the i-th frame of initial image and reference compensation values of the pixel circuits in the i-th frame of initial image; and
a compensation circuit configured to, according to a reference compensation value of a first pixel circuit, initial input data of the first pixel circuit, and initial input data of a second pixel circuit, determine a target compensation value of the first pixel circuit and perform compensation adjustment on the initial input data of the first pixel circuit, wherein the first pixel circuit and the second pixel circuit are located in a same pixel column of the plurality of pixel columns.

16. A display panel, comprising: a plurality of pixel columns, a plurality of data lines, and the driving device according to claim 15,
wherein a pixel column of the plurality of pixel columns comprises a plurality of pixel circuits, and the plurality of pixel circuits are electrically connected to a same data line of the plurality of data lines; and
wherein the driving device is electrically connected to the plurality of data lines and is configured to supply compensated data signals to the plurality of data lines.
